(19) United States
(12) Patent Application Publication
(10) Pub. No.: US 2026/0042689 A1
(43) Pub. Date: Feb. 12, 2026

(54) ASSEMBLED BIORETENTION POND WITH NITROGEN AND PHOSPHORUS REMOVAL FUNCTIONS

(71) Applicants: China Construction Industrial & Energy Engineering Group Co., Ltd, Nanjing (CN); Chongqing University, Chongqing (CN)

(72) Inventors: Fujian Liu, Nanjing (CN); Lei Chen, Chongqing (CN); Yanhong Xu, Nanjing (CN); Hongxiang Chai, Chai (CN); Zihao Xu, Nanjing (CN); Hao Wu, Chongqing (CN); Yu Bai, Chongqing (CN)

(21) Appl. No.: 19/291,599

(22) Filed: Aug. 6, 2025

(30) Foreign Application Priority Data
Aug. 7, 2024 (CN) 202411074166.8

(51) Int. Cl. C02F 3/30; C02F 101/10; C02F 101/16; C02F 103/00

(52) U.S. Cl. CPC C02F 3/308; C02F 2101/105; C02F 2101/16; C02F 2103/001; C02F 2203/006

(57) ABSTRACT

An assembled bioretention pond with nitrogen and phosphorus removal functions includes: a water collecting tank and a plurality of modules. Each module includes an anaerobic chamber and an aerobic chamber, a substrate in the anaerobic chamber is the same as that of the aerobic chamber, including a gravel distribution layer, a planting layer, a pyrite layer, a transition layer, and a gravel layer in sequence from top to bottom, and a ventilation pipe is vertically provided in the aerobic chamber and extends to the gravel layer, a water drainage pipe is mounted on a top of one side of the anaerobic chamber, a main pipe is mounted on a top of one side of the aerobic chamber and connected to a municipal stormwater pipe, a plurality of auxiliary pipes are arranged in the water collecting tank. This solution improves the ability to remove nitrogen and phosphorus pollutants from stormwater.

### CROSS-REFERENCE TO RELATED APPLICATIONS

This application claims priority to Chinese Patent Application No. 202411074166.8, filed on Aug. 7, 2024, which is hereby incorporated by reference in its entirety.

### TECHNICAL FIELD

The present application relates to the technical field of stormwater treatment, and in particular, to an assembled bioretention pond with nitrogen and phosphorus removal functions.

### BACKGROUND

In mountainous cities, rainfall leads to short concentration time and high runoff volume, resulting in complex hydrological conditions. Rainfall runoff erosion increases the threat of pollution. Chinese Patent Publication No. CN116065681A discloses an assembled bioretention facility and a molding method thereof, which solves the problem of stormwater drainage in a water storage space at different water levels, controls the probability of occurrence of urban flooding, but cannot solve the problem of stormwater pollution and cannot be effectively applied in mountainous cities. Chinese Patent Publication No. CN217103489U discloses a bioretention pond, which solves the technical drawbacks of poor runoff regulation and pollution purification performance in bioretention ponds when the permeability coefficient of the filter soil does not meet the standard, especially in the face of heavy rain. However, in actual use, bioretention ponds with similar structures still have many defects. For example, the existing stormwater bioretention facilities in the sponge city cannot effectively remove soluble pollutants in stormwater, such as nitrogen and phosphorus pollution. To further improve the removal capacity of the stormwater bioretention facility for nitrogen and phosphorus pollutants, substrate improvement and structure optimization of the facility become effective ways. However, the method for improving the substrate and structure of stormwater retention facilities still has the defect that the adding proportion of the facility substrate is judged by manual experience, a quantitative decision method suitable for local conditions is lacking. The existing technical solutions mostly adapt to plain landform, and lack effectiveness in mountainous terrain. Different constructors have different modes and proportion control for adding the substrate in the stormwater bioretention facility, and the removal capacity of the facility for nitrogen and phosphorus pollutants is further reduced, so that a nitrogen and phosphorus removal-based assembled bioretention pond needs to be designed.

### SUMMARY

To solve the defects in the prior art, the present application provides an assembled bioretention pond with nitrogen and phosphorus removal functions, which improves the ability to remove nitrogen and phosphorus pollutants from stormwater.

To achieve the objective of the present application, the following technical solutions are adopted.

An assembled bioretention pond with nitrogen and phosphorus removal functions includes: a water collecting tank and a plurality of modules.

Each module includes an anaerobic chamber and an aerobic chamber, a substrate in the anaerobic chamber is the same as that of the aerobic chamber, including a gravel distribution layer, a planting layer, a pyrite layer, a transition layer, and a gravel layer in sequence from top to bottom, the anaerobic chamber and the aerobic chamber are connected at the gravel layer by a water transfer pipe, the aerobic chamber is connected to the water collecting tank by a water collecting pipe, the water collecting pipe is also connected to the gravel layer of the aerobic chamber, the water transfer pipe and the water collecting pipe are positioned at opposite sides of the aerobic chamber, a ventilation pipe is vertically provided in the aerobic chamber, a bottom of the ventilation pipe extends to the gravel layer, and the ventilation pipe is configured to provide oxygen to the aerobic chamber to improve a stormwater purification efficiency.

A water drainage pipe is mounted on a top of one side of the anaerobic chamber and is configured to drain stormwater into the anaerobic chamber, a main pipe is mounted on a top of one side of the aerobic chamber and is connected to a municipal stormwater pipe, a plurality of auxiliary pipes are arranged in the water collecting tank, a top of the auxiliary pipe is connected to the main pipe, the auxiliary pipe is configured to pump water from the water collecting tank, a plurality of clamps are mounted on an outer wall of the main pipe, and two ends of the clamp are fixedly connected to an edge of the water collecting tank by screws. To improve the stability of the ventilation pipe, the ventilation pipe is fixedly connected to the clamp on the outer wall of the main pipe by a mounting member.

Further, a substrate medium of the planting layer is a mixture of sandy loam and quartz sand with a volume ratio of 14-17:86-83, a permeation rate of the planting layer is not less than 150 mm/h, a depth of the planting layer is not less than 450 mm, the planting layer is configured to plant plants, and pollutants in stormwater are preliminarily purified by the plants.

Further, a substrate medium of the pyrite layer is a mixture of pyrite and quartz sand with a volume ratio is 2-3:8-7, a depth of the pyrite layer is 450 mm-550 mm, and the pyrite layer may improve the efficiency of nitrogen and phosphorus removal in stormwater by autotrophic denitrification of pyrite.

Further, a substrate medium of the transition layer is quartz sand with particle sizes in proportions of 5% for 5-10 mesh, 10% for 10-20 mesh, 30% for 20-30 mesh, 30% for 30-60 mesh, and 25% for 60-140 mesh, a depth of the transition layer is not less than 100 mm, a depth of the gravel layer is not less than 100 mm, and the transition layer may effectively filter impurities in stormwater and prevent impurities from entering the water transfer pipe or water collecting pipe.

The working principle of the bioretention pond is as follows: the water drainage pipe drains stormwater into the corresponding anaerobic chamber; after the anaerobic chamber performs primary purification on the stormwater, the stormwater flows into the aerobic chamber through the water transfer pipe; after the aerobic chamber performs secondary purification on the stormwater, the stormwater flows into the water collecting tank through the water collecting pipe; the water collecting tank may store purified stormwater, so that the stormwater reduction effect is achieved, and the flood prevention and water management is improved; the purified stormwater may be reused, so that water resources are saved; and the stormwater in the water collecting tank may be pumped to the main pipe through the auxiliary pipe and finally flows into the municipal storm water pipe.

A local runoff volume control capacity is determined by:

$$V = 1 {0}^{- 3} DF φ$$

where:
V—local runoff volume control capacity (m3);
D—design rainfall depth (mm) corresponding to the annual runoff volume control rate of the bioretention pond, which shall be determined in accordance with the current national standard “Evaluation Standard for Sponge City Construction” GB/T 51345;
F—catchment area served by the bioretention pond (m2);
φ—comprehensive rainfall-runoff coefficient of the catchment area served by the bioretention pond.

The local rainfall conditions are investigated to determine the rainfall volume, catchment area, and construction scope. The number of modules and a combined area thereof in the bioretention pond are determined based on local conditions.

The number of modules in the bioretention pond is determined by:

$$n = V / m$$

where:
n—the number of modules in the bioretention pond;
V—local runoff volume control capacity (m3);
m—unit area of modules in the bioretention pond (m2). It is recommended to set a module dimensions as 1000 mm×1000 mm, i.e., a total combined area of 1 m2 for each aerobic chamber and anaerobic chamber.

Further, the specific connection between the ventilation pipe and the mounting member is as follows: a collar is fixedly provided on an outer wall of the ventilation pipe, an L-shaped plate is provided on an outer wall of the collar, the mounting member includes a base, a locking block and a cover plate, the base is fixedly provided on an edge of the water collecting tank, a first groove, a second groove and a third groove which are interconnected are provided on a top of the base, where the second groove is parallel to the third groove, the first groove passes through centers of the second groove and the third groove, a long axis of the first groove is parallel to a long axis of the main pipe, and end parts of the second groove and the third groove both pass through a side wall of the base; the locking block is slidably arranged in the first groove, one end of the locking block is positioned in the third groove and is semicircular, the other end of the locking block is connected to the base by a spring, an avoidance groove is provided on a top of the locking block, the L-shaped plate is assembled in the second groove, a longitudinal segment of the L-shaped plate passes through the avoidance groove, a right-angled part of the L-shaped plate faces one side of the spring and hooks the locking block, and the cover plate covers the base and is connected to a first end of the clamp by a screw, and is configured to unlock the L-shaped plate when the locking block is squeezed by inserting a latch into the third groove.

Further, a width of the second groove is consistent with a size of a horizontal segment of the L-shaped plate, a top surface of the L-shaped plate is close to the cover plate, and the horizontal segment of the L-shaped plate is close to an end surface of the clamp.

Further, a limiting groove is provided at a top of the first end of the clamp, a block is provided at one side of the cover plate facing the clamp, and the block matches in the limiting groove, so that the block may further improve the stability of the cover plate and prevent the cover plate from shifting in a horizontal plane and deviating from the base.

Further, the water transfer pipe is arranged obliquely downwards in a direction from the anaerobic chamber to the aerobic chamber.

Further, outer walls of the water transfer pipe and the water collecting pipe are provided with an anti-permeation layer and a waterproof layer, the anti-permeation layer is positioned on an inner side of the waterproof layer, and the anti-permeation layer and the waterproof layer play a protective role, so that the phenomenon that water in soil permeates into the water transfer pipe or the water collecting pipe to pollute purified stormwater is avoided.

The beneficial effects of the present application are as follows.

1. The number of modules may be determined according to the local rainfall conditions and construction scope. The anaerobic chamber and the aerobic chamber are used as one module, and the two chambers may achieve different pollutant removal effects. The setting of the pyrite layer improves the efficiency of nitrogen and phosphorus pollutant removal; the anaerobic chamber and the aerobic chamber may store stormwater, which not only has a flood control effect, but also is conducive to the full purification of stormwater; the water collecting tank may store purified stormwater to achieve the effect of reducing stormwater and improve the efficiency of flood control and water management; and the purified stormwater may be reused, so that water resources are saved.

2. The assembled substrate filling module ensures the stability of the substrate ratio and avoids the problem of incorrect filling due to on-site construction. Meanwhile, the assembled module saves construction land and is suitable for sponge city construction in mountainous cities.

### BRIEF DESCRIPTION OF THE DRAWINGS

FIG. 1 is a structural diagram of a bioretention pond;

FIG. 2 is a top view of a bioretention pond;

FIG. 3 is a front view of a bioretention pond;

FIG. 4 is a schematic diagram of substrate distribution inside an aerobic chamber;

FIG. 5 is a diagram of an internal structure of a mounting member;

FIG. 6 is a top view of the interior of a mounting member; and

FIG. 7 is a structural diagram of a cover plate.

Reference numerals: 1. anaerobic chamber, 101. gravel distribution layer, 102. planting layer, 103. pyrite layer, 104. transition layer, 105. gravel layer, 2. aerobic chamber, 3. water collecting tank, 31. auxiliary pipe, 41. water transfer pipe, 42. water collecting pipe, 43. water drainage pipe, 44. main pipe, 45. ventilation pipe, 451. collar, 452. L-shaped plate, 61. clamp, 611. limiting groove, 62. screw, 7. mounting member, 71. base, 711. first groove, 712. second groove, 713. third groove, 72. locking block, 721. avoidance groove, 73. cover plate, 731. block, and 74. spring.

### DESCRIPTION OF EMBODIMENTS

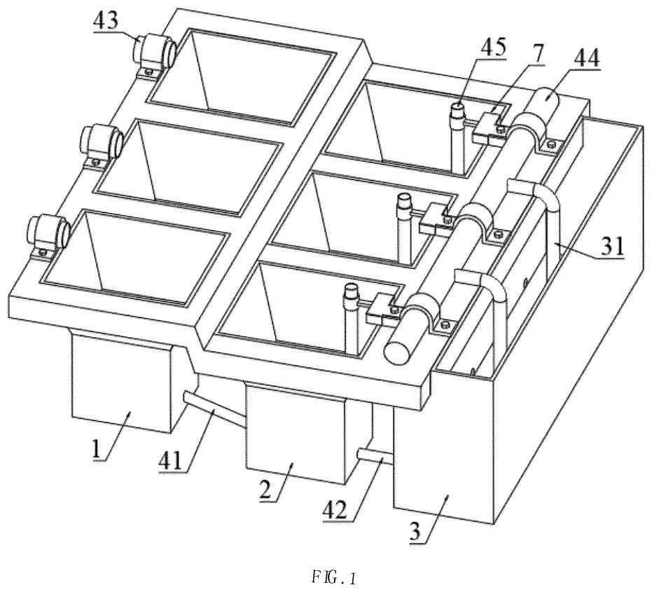

As shown in FIG. 1, an embodiment provides an assembled bioretention pond with nitrogen and phosphorus removal functions, which includes: a water collecting tank 3 and three modules.

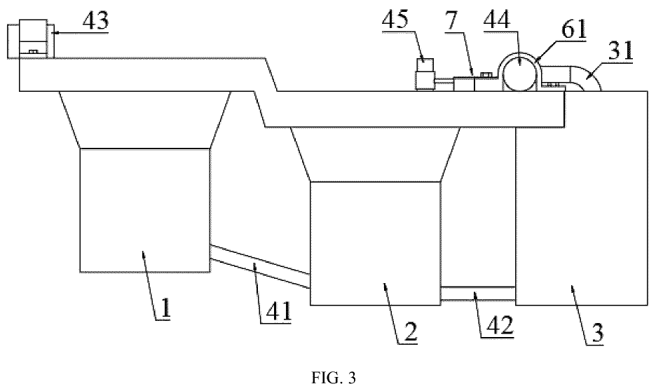

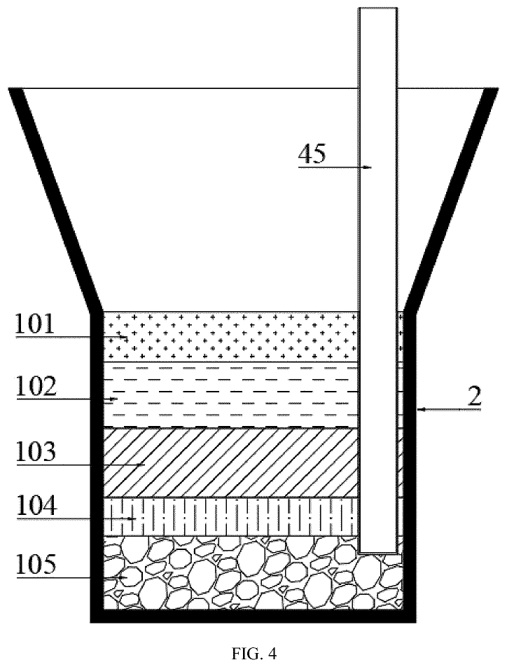

Specifically, each module includes an anaerobic chamber 1 and an aerobic chamber 2, a substrate in the anaerobic chamber 1 is the same as that of the aerobic chamber 2, as shown in FIG. 4, which includes a gravel distribution layer 101, a planting layer 102, a pyrite layer 103, a transition layer 104, and a gravel layer 105 in sequence from top to bottom, and the anaerobic chamber 1 and the aerobic chamber 2 are connected at the gravel layer 105 by a water transfer pipe 41. That is, as shown in FIG. 3 and FIG. 4, one end of the water transfer pipe 41 is connected to the gravel layer 105 of the anaerobic chamber 1, and the other end of the water transfer pipe 41 is connected to the gravel layer 105 of the aerobic chamber 2. To facilitate the flow of stormwater, the water transfer pipe 41 is arranged obliquely downward from the anaerobic chamber 1 to the aerobic chamber 2. The aerobic chamber 2 is connected to the water collecting tank 3 through the water collecting pipe 42, and the water collecting pipe 42 is also connected to the gravel layer 105 of the aerobic chamber 2. The water collecting pipe 42 and the water transfer pipe 41 are respectively positioned at opposite sides of the aerobic chamber 2. A ventilation pipe 45 is vertically arranged in the aerobic chamber 2, and a bottom of the ventilation pipe 45 extends to the gravel layer 105.

More specifically, the outer walls of the water transfer pipe 41 and the water collecting pipe 42 are provided with an anti-permeation layer 51, a waterproof layer 52 is provided on an outer side of the anti-permeation layer 51, and the anti-permeation layer 51 and the waterproof layer 52 play a protective role, so that the phenomenon that water in soil permeates into the water transfer pipe 41 or the water collecting pipe 42 to pollute purified stormwater is avoided.

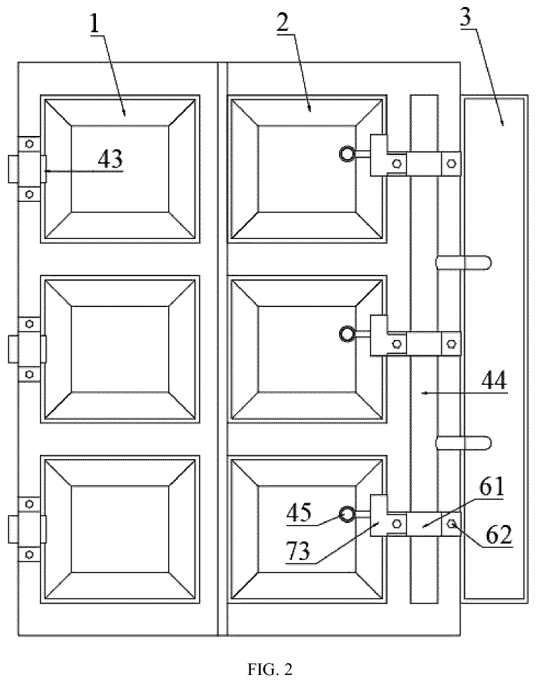

Specifically, as shown in FIG. 2 and FIG. 3, a water drainage pipe 43 is mounted at a top of one side of the anaerobic chamber 1, the water drainage pipe 43 is configured to drain stormwater into the anaerobic chamber 1, a plurality of clamps 61 are mounted on an outer wall of the water drainage pipe 43, two ends of the clamp 61 are fixedly connected to an edge of the water collecting tank by screws 62, a main pipe 44 is mounted at a top of one side of the aerobic chamber 2, the main pipe 44 is positioned between the aerobic chamber 2 and the water collecting tank 3, the main pipe 44 is connected to a municipal stormwater pipe, two auxiliary pipes 31 are arranged in the water collecting tank 3, a top of the auxiliary pipe 31 is connected to the main pipe 44, the auxiliary pipe 31 is configured to pump water from the water collecting tank 3, a plurality of clamps 61 are mounted on an outer wall of the main pipe 44, and two ends of the clamp 61 are fixedly connected to an edge of the water collecting tank by screws 62.

More specifically, a substrate medium of the planting layer 102 is a mixture of sandy loam and quartz sand with a volume ratio of 14:86, the planting layer 102 is configured to plant plants, and to ensure the normal growth of the plants, the planting layer 102 has a penetration rate of 150 mm/h and a depth of 450 mm.

More specifically, a substrate medium of the pyrite layer 103 is a mixture of pyrite and quartz sand with a volume ratio is 3:7, a depth of the pyrite layer 103 is 450 mm, and the pyrite layer 103 is configured to remove nitrogen and phosphorus in the stormwater.

More specifically, a substrate medium of the transition layer 104 is quartz sand with particle sizes in proportions of 5% for 5-10 mesh, 10% for 10-20 mesh, 30% for 20-30 mesh, 30% for 30-60 mesh, and 25% for 60-140 mesh, a depth of the transition layer 104 is 100 mm, a depth of the gravel layer 105 is 100 mm, and the transition layer 104 is configured to intercept impurities in stormwater to prevent the impurities from entering the water transfer pipe 41 or the water collecting pipe 42.

The working principle of the bioretention pond is as follows: the water collecting pipe 42 is in a closed state, and the three water drainage pipes 43 drain stormwater into the corresponding anaerobic chamber 1; the stormwater in the anaerobic chamber 1 sequentially flows through the gravel distribution layer 101, the planting layer 102, the pyrite layer 103, the transition layer 104 and the gravel layer 105, and after the anaerobic chamber 1 performs primary purification on the stormwater, the stormwater flows into the gravel layer 105 of the aerobic chamber 2 through the water transfer pipe 41; since the water collecting pipe 42 is in a closed state, the liquid level of the stormwater in the aerobic chamber 2 is gradually increased to the gravel distribution layer 101, and the stormwater stored in the aerobic chamber 2 not only has a flood control effect, but also is beneficial to purifying the stormwater; after the aerobic chamber 2 performs secondary purification on the stormwater, the water collecting pipe 42 is in an open state, and the stormwater in the aerobic chamber 2 flows into the water collecting tank 3 through the water collecting pipe 42; the water collecting tank 3 may store purified stormwater, so that the stormwater reduction effect is achieved, and the flood prevention and water management is improved; the purified stormwater may be reused, so that water resources are saved; and the stormwater in the water collecting tank 3 may be pumped to the main pipe 44 through the auxiliary pipe 31 and finally flows into the municipal stormwater pipe.

In actual application, the number of modules is determined according to the local rainfall conditions and the construction scope:
S1. determining a shape, an area and a depth of the bioretention pond according to the local rainfall conditions, soil nitrogen and phosphorus pollution conditions, and a construction scope of a mountainous terrain reduction area; and
S2. determining the number of modules in the bioretention pond and a ratio of internal substrates of the anaerobic chamber 1 and the aerobic chamber 2 according to the local rainfall conditions and soil nitrogen and phosphorus pollution conditions.

If the ventilation pipe 45 is simply inserted vertically into the aerobic chamber 2, there may be a problem that the ventilation pipe 45 falls over or shifts up and down. Therefore, the ventilation pipe 45 of this embodiment is fixedly connected to the clamp 61 on the outer wall of the main pipe 44 by the mounting member 7. The specific implementation is as follows:

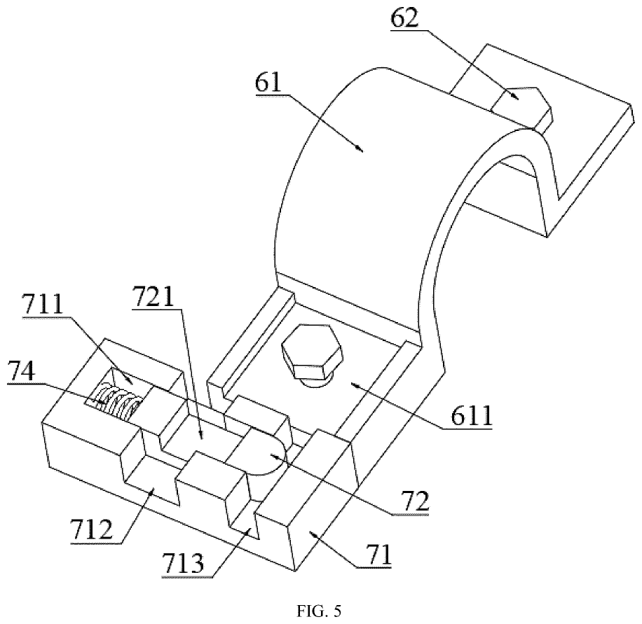

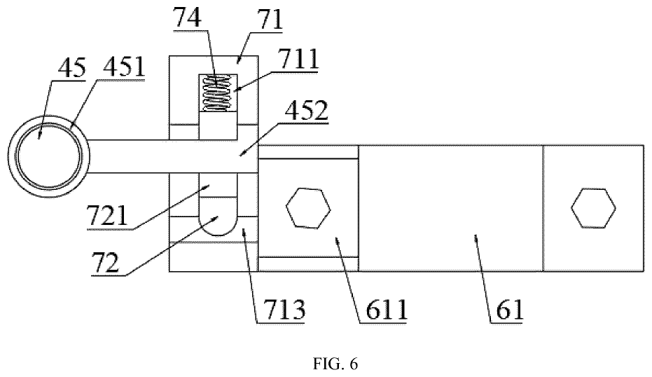

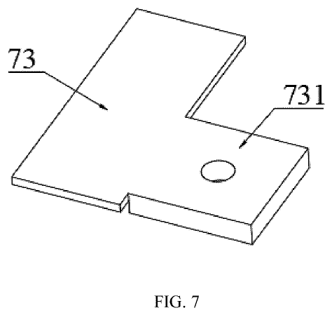

As shown in FIGS. 1 and 5-7, a collar 451 is fixedly provided on an outer wall of the ventilation pipe 45, an L-shaped plate 452 is provided on an outer wall of the collar 451, and a longitudinal segment of the L-shaped plate 452 is connected to the collar 451. The mounting member 7 includes a base 71, a locking block 72 and a cover plate 73, and the base 71 is fixedly arranged at an edge of the water collecting tank or at an end surface of a first end of the collar 61. A first groove 711, a second groove 712 and a third groove 713 which are interconnected are provided on a top of the base 71, where the second groove 712 is parallel to the third groove 713, the first groove 711 passes through centers of the second groove 712 and the third groove 713, a long axis of the first groove 711 is parallel to a long axis of the main pipe 44, and end parts of the second groove 712 and the third groove 713 both pass through a side wall of the base 71. The locking block 72 is slidably arranged in the first groove 711, a first end of the locking block 72 is positioned in the third groove 713, the first end of the locking block 72 is semicircular, and a second end of the locking block 72 is connected to the base 71 by a spring 74. An avoidance groove 721 is provided on the top of the locking block 72, and the avoidance groove 721 passes through the locking block 72 in a direction along the second groove 712. The L-shaped plate 452 is assembled in the second groove 712, and the longitudinal segment of the L-shaped plate 452 passes through the avoidance groove 721. There is a gap between the longitudinal segment of the L-shaped plate 452 and the first end of the locking block 72. A right-angle part of the L-shaped plate 452 faces one side of the spring 74, and the right-angle part hooks the second end of the locking block 72. The cover plate 73 covers the base 71, and the cover plate 73 is connected to the first end of the clamp 61 by a screw 62.

When the locking block 72 is squeezed by inserting a latch into the third groove 713, the locking block 72 moves toward the spring 74. The spring 74 is compressed, and the L-shaped plate 452 may be removed after the horizontal segment of the L-shaped plate 452 loses the restriction of the second end of the locking block 72, so that the disassembly is very convenient.

When it is necessary to lock the L-shaped plate 452, there are two ways:

Firstly, when the clamp 61 is mounted, the second end of the clamp 61 is fixed with one screw 62, i.e., one end of the clamp 61 far away from the mounting member 7, and the cover plate 73 is not mounted. Since the cover plate 73 is not mounted, the L-shaped plate 452 is directly placed in a preset position of the base 71; then the cover plate 73 is covered, and the cover plate 73 and the first end of the clamp 61 are fixed with another screw 62.

Secondly, when the clamp 61 is mounted, the second end of the clamp 61 is fixed with one screw 62, i.e., one end of the clamp 61 far away from the mounting member 7, the cover plate 73 is covered, and the cover plate 73 and the first end of the clamp 61 are fixed with another screw 62. An operator holds the latch and inserts the latch into the third groove 713 to squeeze the locking block 72, the locking block 72 moves toward the spring 74, and the spring 74 is compressed. In this case, the horizontal segment of the L-shaped plate 452 is inserted into the second groove 712. After the latch is removed, the second end of the locking block 72 locks the L-shaped plate 452 under the action of the spring 74, so that the mounting is also very convenient.

It is noted here that, in actual application, each mounting member 7 may be equipped with a latch, and the latch is hung at a preset position by a rope or chain, such as hanging on the L-shaped plate 452; or all mounting members 7 may share one latch, and this latch is kept by the operator and does not need to be arranged at the preset position.

More specifically, to further improve the stability of the ventilation pipe 45, a width of the second groove 712 is consistent with a size of a horizontal segment of the L-shaped plate 452, the top surface of the L-shaped plate 452 is close to the cover plate 73, and the horizontal segment of the L-shaped plate 452 is close to the end surface of the first end of the clamp 61.

More specifically, to further improve the stability of the cover plate 73, a limiting groove 611 is provided at a top of the first end of the clamp 61, a block 731 is provided at one side of the cover plate 73 facing the clamp 61, and the block 731 matches in the limiting groove 611.

The foregoing embodiments are only used to illustrate the technical ideas and features of the present application, and are not intended to be the only ones or to limit the present application. Those skilled in the art should understand that various changes or equivalent substitutions made to the present application without departing from the scope of the present application all fall within the scope of protection of the present application.

What is claimed is:

1. An assembled bioretention pond with nitrogen and phosphorus removal functions, comprising: a water collecting tank and a plurality of modules; wherein
each module comprises an anaerobic chamber and an aerobic chamber, a substrate in the anaerobic chamber is the same as a substrate in the aerobic chamber, the substrate comprises a gravel distribution layer, a planting layer, a pyrite layer, a transition layer, and a gravel layer in sequence from top to bottom, the anaerobic chamber and the aerobic chamber are connected at the gravel layer by a water transfer pipe, the aerobic chamber is connected to the water collecting tank by a water collecting pipe, and a ventilation pipe is vertically provided in the aerobic chamber and extends to the gravel layer;
a water drainage pipe is mounted on a top of one side of the anaerobic chamber and is configured to drain stormwater into the anaerobic chamber, a main pipe is mounted on a top of one side of the aerobic chamber and is connected to a municipal stormwater pipe, a plurality of auxiliary pipes are arranged in the water collecting tank, a top of the auxiliary pipe is connected to the main pipe, the auxiliary pipe is configured to pump water from the water collecting tank, a plurality of clamps are mounted on an outer wall of the main pipe, two ends of the clamp are fixedly connected to an edge of the water collecting tank by screws, and the ventilation pipe is fixedly connected to the clamp on the outer wall of the main pipe by a mounting member;
a collar is fixedly provided on an outer wall of the ventilation pipe, an L-shaped plate is provided on an outer wall of the collar, the mounting member comprises a base, a locking block and a cover plate, the base is fixedly provided on an edge of the water collecting tank, a first groove, a second groove and a third groove are interconnected and provided on a top of the base, wherein the second groove is parallel to the third groove, the first groove passes through centers of the second groove and the third groove, a long axis of the first groove is parallel to a long axis of the main pipe, and end parts of the second groove and the third groove both pass through a side wall of the base; the locking block is slidably arranged in the first groove, one end of the locking block is positioned in the third groove and is semicircular, the other end of the locking block is connected to the base by a spring, an avoidance groove is provided on a top of the locking block, the L-shaped plate is assembled in the second groove, a longitudinal segment of the L-shaped plate passes through the avoidance groove, a right-angled part of the L-shaped plate faces one side of the spring and hooks the locking block, and the cover plate covers the base and is connected to a first end of the clamp by a screw, and is configured to unlock the L-shaped plate when the locking block is squeezed by inserting a latch into the third groove.

2. The assembled bioretention pond with nitrogen and phosphorus removal functions according to claim 1, wherein a width of the second groove is consistent with a size of a horizontal segment of the L-shaped plate, a top surface of the L-shaped plate is close to the cover plate, and the horizontal segment of the L-shaped plate is close to an end surface of the clamp.

3. The assembled bioretention pond with nitrogen and phosphorus removal functions according to claim 2, wherein a limiting groove is provided at a top of the first end of the clamp, a block is provided at one side of the cover plate facing the clamp, and the block matches in the limiting groove.

4. The assembled bioretention pond with nitrogen and phosphorus removal functions according to claim 1, wherein the water transfer pipe is arranged obliquely downwards in a direction from the anaerobic chamber to the aerobic chamber.

5. The assembled bioretention pond with nitrogen and phosphorus removal functions according to claim 1, wherein outer walls of the water transfer pipe and the water collecting pipe are provided with an anti-permeation layer and a waterproof layer, and the anti-permeation layer is positioned on an inner side of the waterproof layer.

6. The assembled bioretention pond with nitrogen and phosphorus removal functions according to claim 1, wherein a substrate medium of the planting layer is a mixture of sandy loam and quartz sand with a volume ratio of 14-17:86-83, a permeation rate of the planting layer is not less than 150 mm/h, and a depth of the planting layer is not less than 450 mm.

7. The assembled bioretention pond with nitrogen and phosphorus removal functions according to claim 1, wherein a substrate medium of the pyrite layer is a mixture of pyrite and quartz sand with a volume ratio is 2-3:8-7, and a depth of the pyrite layer is 450 mm-550 mm.

8. The assembled bioretention pond with nitrogen and phosphorus removal functions according to claim 1, wherein a substrate medium of the transition layer is quartz sand with particle sizes in proportions of 5% for 5-10 mesh, 10% for 10-20 mesh, 30% for 20-30 mesh, 30% for 30-60 mesh, and 25% for 60-140 mesh, and a depth of the transition layer is not less than 100 mm.

9. The assembled bioretention pond with nitrogen and phosphorus removal functions according to claim 1, wherein a horizontal area of the module is 1000 mm×1000 mm.
